(19) United States
(12) Patent Application Publication
(10) Pub. No.: US 2025/0138615 A1
(43) Pub. Date: May 1, 2025

(54) DROOP PROTECTION METHOD AND CIRCUIT

(71) Applicant: Arm Limited, Cambridge (GB)

(72) Inventors: Rainer Herberholz, Great Abington (GB); Amit Chhabra, Noida (IN)

(73) Assignee: Arm Limited, Cambridge (GB)

(21) Appl. No.: 18/925,406

(22) Filed: Oct. 24, 2024

(30) Foreign Application Priority Data
Oct. 27, 2023 (IN) 202311073295
Mar. 20, 2024 (GB) 2403977.8

(51) Int. Cl. G06F 1/30; G06F 1/26; G06F 1/28

(52) U.S. Cl. CPC G06F 1/30; G06F 1/263; G06F 1/28

(57) ABSTRACT

The present techniques relate to mitigating droop conditions in systems having dynamic voltage and frequency scaling and there is disclosed a method of controlling a dynamic voltage and frequency scaling circuit, comprising: detecting a voltage droop relative to a current nominal voltage and frequency state; responsive to said current nominal voltage and frequency state having a corresponding fallback state in a safe operating zone of voltage and frequency, switching activity from a nominal source to a fallback source; and when a fallback to a safe operating zone is unavailable for said current nominal voltage and frequency state, pausing activity of the dynamic voltage and frequency scaling circuit.

### TECHNICAL FIELD

The present technology is directed to a method and electronic circuit for mitigating droop conditions in systems having dynamic voltage and frequency scaling.

### BACKGROUND OF THE DISCLOSURE

Some computer circuits (e.g. a central processor unit (CPU) or graphics processor unit (GPU)) may experience performance issues. For example, a CPU can generate voltage droops due to large changes in current required from a power delivery network (PDN).

There is a need for mitigation action to address such performance issues.

### SUMMARY OF THE DISCLOSURE

The present techniques relate to addressing or mitigating such performance issues or improving known mitigation techniques.

In an approach to addressing some difficulties in mitigating droop conditions in systems having dynamic voltage and frequency scaling, the present technology provides, in a first approach, a method of controlling a dynamic voltage and frequency scaling circuit, comprising: detecting a voltage droop relative to a current nominal voltage and frequency state; responsive to said current nominal voltage and frequency state having a corresponding fallback state in a safe operating zone of voltage and frequency, switching activity from a nominal source to a fallback source; and when a fallback to a safe operating zone is unavailable for said current nominal voltage and frequency state, pausing activity of the dynamic voltage and frequency scaling circuit.

The dynamic voltage and frequency scaling circuit may comprise a clock circuit, wherein the nominal source may comprise a first phase locked loop and wherein the fallback source comprises a second phase locked loop.

The safe operating zone may comprise a zone of the voltage domain in which there is sufficient available frequency reduction to permit continued operation in case of a maximum possible voltage droop, and where outside the safe operating zone may comprise at least one zone of the voltage domain in which a maximum possible voltage droop risks rendering the circuit inoperable.

In a further approach there is provided a method of controlling a dynamic voltage and frequency scaling circuit, comprising: detecting a voltage droop relative to a current nominal voltage and frequency state; when a fallback to a safe operating zone is unavailable for said current nominal voltage and frequency state, pausing activity of the dynamic voltage and frequency scaling circuit.

In a further approach there is provided an electronic circuit comprising electronic logic components operable to perform the steps of the above method.

In a further approach there is provided a non-transitory computer readable medium comprising a structure of data and imperatives operable to cause a device to construct a set of electronic logic components which, when embedded in an electronic device and activated thereon, cause the electronic device to perform the steps of the above method.

In a further approach there is provided a system comprising: the above electronic circuit, implemented in at least one packaged chip; at least one system component; and a board, wherein the at least one packaged chip and the at least one system component are assembled on the board.

In a further approach there is provided a chip-containing product comprising the above system assembled on a further board with at least one other product component.

In a further approach there is provided a non-transitory computer-readable medium to store computer-readable code for fabrication of the above electronic circuit.

The method and circuit according to the present technology may thus be used in mitigating droop conditions in systems having dynamic voltage and frequency scaling, and that method may be realised in the form of a non-transitory computer readable medium comprising a structure of data and imperatives operable to cause a device to construct a set of electronic logic components which, when embedded in an electronic device and activated thereon, cause the electronic device to perform the steps of the method of the present technology as described hereinabove.

As will be clear to one of skill in the art, a hybrid approach may also be taken, in which hardware logic, firmware and/or software may be used in any combination to implement the present technology.

### BRIEF DESCRIPTION OF DRAWINGS

Implementations of the disclosed technology will now be described, by way of example only, with reference to the accompanying drawings, in which:

FIG. 1 shows a simplified example of a method of operation according to an implementation of the present technology;

FIG. 2A shows a voltage-frequency graph to give an example of an implementation of the present technology;

FIG. 2B shows a simplified voltage-frequency graph to give an example of an implementation of the present technology;

FIG. 3 shows a simple example of a multiplex arrangement according to an implementation of the present technology; and

FIG. 4 illustrates a system and a chip-containing product.

### DETAILED DESCRIPTION

In integrated circuits, a droop is a (usually) transient lowering of the voltage in a circuit. This is a well-known phenomenon and can happen because, for example, the power supply dips for some reason below a normal operating voltage of the circuit, because more current is drawn by the conductive elements than the normal current drawn, or because signal interference or noise on the power supply has caused a voltage fluctuation.

Droops can impact the operations of a circuit, for example by reducing the performance of the circuit and thus leading to longer processing times. But there may be more serious effects also—for example, if the circuit draws more current to maintain the level of performance, this can lead to increased power consumption and the concomitant heat dissipation problems, which can lead to reduced life of the device and in severe cases, a complete device. Droops can also cause data corruption or errors in the output. This is a very serious issue for applications that depend on the accuracy and reliability of the chip, for example, in safety-critical applications, such as automotive or avionics systems.

The present techniques address some of the problems inherent in implementing a dynamic voltage and frequency scaling (DVFS) circuit in combination with a droop mitigation scheme. Use cases for the present technology may include, for example, systems in which it is necessary to maintain accuracy of, for example, a clock out signal. Such systems may include, for example, systems needing failure resistance for safety reasons, such as automotive and avionics control systems, medical apparatus control systems and the like.

In a dynamic voltage and frequency scaling (DVFS) circuit, such as a clock circuit, having a droop mitigation scheme, a first clock source (for instance, PLL0) may provide a first clock called “NOM clock” and a second clock source (for instance, PLL1) provides a second clock called “FB clock”. The frequency of the FB clock may be set lower than the frequency of “NOM clock,” thus compensating for voltage droop effects by reducing the frequency of the clock pulses. The NOM (for “nominal”) clock is normally used to drive the output clock. In case of a supply droop event, the FB (for “fallback”) clock is used to drive the output clock as a droop mitigation technique.

The droop mitigation technique envisioned here is one in which a voltage droop is allowed for by providing the ability to reduce the frequency of the circuit's clock operation to match the reduced voltage resulting from the droop. This is achieved by providing a fallback frequency, typically by switching from the normal clock source (which may be referred to as the “nominal” clock) to a clock source with a lower frequency (which may be referred to as the “fallback” clock).

However, there are limits to the use of such a fallback method in mitigating the effects of voltage droops, and thus the present technology addresses the problem of permitting fallbacks to occur when there is sufficient “safe zone” leeway in the system—that is, where the lowest point of any possible droop to be protected by a fallback frequency still lies above the lower operating limit of the circuit—to allow this, and to provide a pause in activity where there is insufficient leeway to permit a further fallback.

The present technology thus relates to how to perform a droop mitigation scheme in combination with DVFS (dynamic voltage and frequency scaling). In particular, the present techniques propose a way to deal with droop events in the lowest DVFS mode. In a droop mitigation scheme, the clock operates at a nominal frequency. The clock may switch to a lower fallback frequency upon detection of a droop event. By nature of the droop event, the supply voltage will also drop. This means that for the duration of the droop event, the voltage vs frequency operating point will move further down the DFVS curve. Mitigating droop events in this manner is safe as far as the hold time is closed at the lowest voltage in the DVFS curve. For the lowest voltage in the DVFS curve, mitigating droop events in this manner can be unsafe due to hold time violations—this may be called a sign-off event. So, instead of switching to fallback, the present technology provides a method of pausing the clock during the droop event duration.

A sign-off event is thus a droop for which the application of the fall-back clock frequency is not sufficient to ensure correct execution of the circuit function. This can be the result of a rare, deep droop event, brown-out from the power-source or the response programmed when the circuit's nominal operation point is already at the lower voltage bound, where droop includes the risk of hold-timing failures as opposed to the set-up timing failures addressed by frequency reduction. In the present implementation of the technology, the response to a sign-off event is therefore to hold the clock and rely on static data retention within the circuit until the sign-off event has passed.

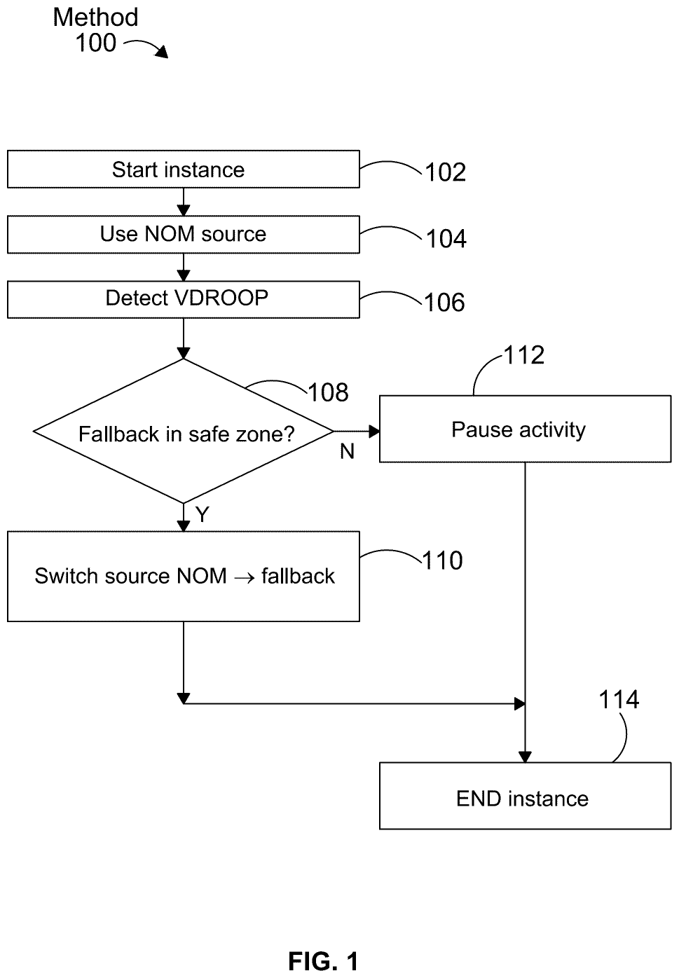

Turning first to FIG. 1, there is shown a simplified flow diagram of a method 100 of controlling a dynamic voltage and frequency scaling (DVFS) circuit according to one implementation of the present techniques. An instance of the method starts at 102, and at first, the circuit is operated 104 using an input NOM as the source. The voltage at NOM may be supplied at a predetermined frequency, for example, in a clock circuit by a phase locked loop (PLL). At 106, it is detected that there is a voltage droop. At 108, it is determined whether there is room in a safe operating zone for a fallback to a lower frequency of the DVFS circuit.

If there is a lower frequency fallback that lies within a safe operating zone (or where the safe operating zone is available)—that is, where the fallback frequency and voltage are sufficient to meet the needs of the circuit during a voltage droop condition, the circuit is switched to use FALLBACK as the source, instead of NOM, and this instance of the method 100 ends at 114. As will be immediately clear to one of ordinary skill in the art, this ending applies to a single instance of the method 100, and in a real world scenario, multiple instances of the method 100 may be started at 102 and completed at 114.

If there is at 108 no available lower frequency where the fallback frequency and voltage are sufficient to meet the needs of the circuit (typically where the lowest point of any droop and therefore the lowest frequency/voltage point of a fallback source would lie below the safe operating zone in which the circuit can properly operate), activity is paused 112 for the duration of the droop condition, and this instance of the method 100 ends at 114. As will be immediately clear to one of ordinary skill in the art, this ending applies to a single instance of the method 100, and in a real world scenario, multiple instances of the method 100 may be started at 102 and completed at 114.

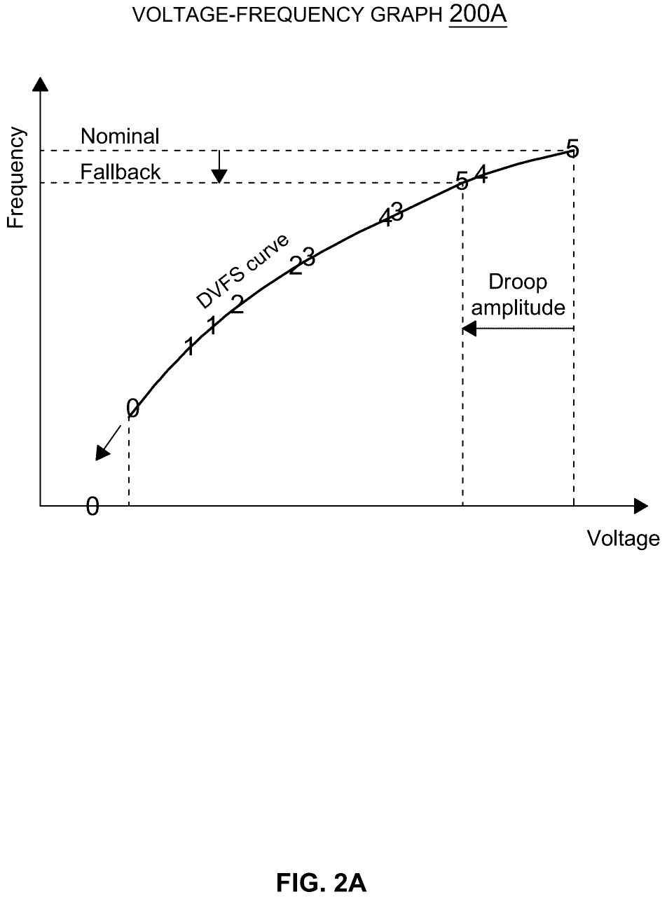

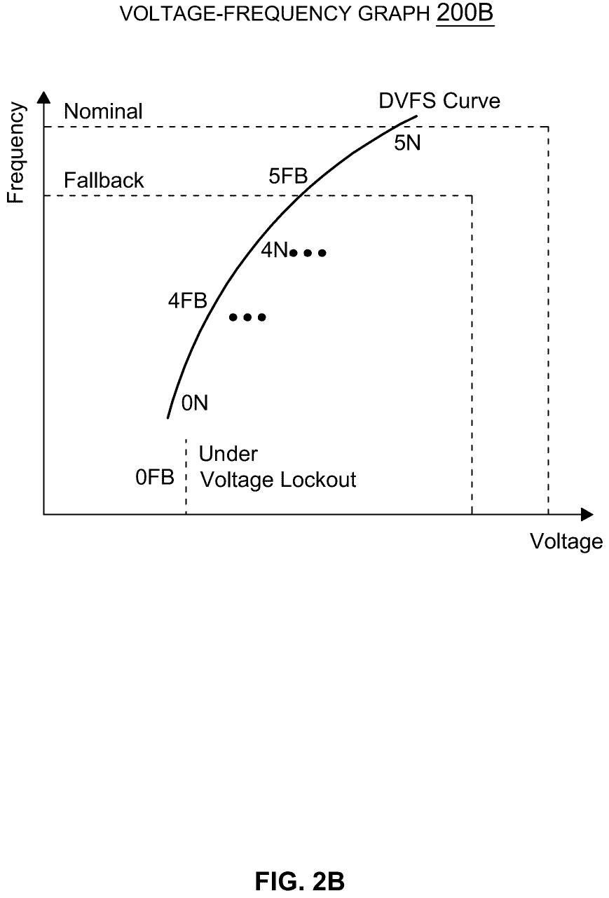

With reference now to FIG. 2A, there is shown a voltage-frequency graph 200A to give a simple example of an implementation of the present technology. FIG. 2A shows one example of the voltage and frequency behaviour of a system operable according to an implementation of the present techniques. The red numbers 0-5 show the nominal frequency and voltage in the given DVFS mode. The green numbers 0-5 show the operating point under droop mitigation, where the fallback frequency is used and the voltage drops by a droop amplitude. As shown, under droop mitigation in modes 1-5, the operating point can be made to stay on the DVFS curve. In mode 0, instead of switching to a fallback frequency, the clock is simply paused or gated.

With reference now to FIG. 2B, there is shown a simplified version of the same voltage-frequency graph 200B to give an example of an implementation of the present technology. As can be seen in the Figure, where frequency is mapped against voltage, the variations in the frequency and voltage can be represented by the DVFS CURVE. As voltage decreases, so the droop mitigation technology according to the present techniques provides a fallback to a source at a reduced frequency to compensate. For example, nominal voltage/frequency 5N in this example is the highest voltage supply source and operates at the highest of the available frequencies. Its corresponding fallback for a droop in voltage shown by a slide back down the curve is 5FB, where the source available to be selected when a droop is detected can operate at a reduced frequency. The difference is represented by the dotted lines NOMINAL and FEEDBACK, between which is the zone within which a droop can be accommodated at this level. Similarly, nominal source 4N can be provided with fallback 4FB, and so on. The further levels may continue with 3N/3FB, etc., not shown here. All these example pairings of N and FB lie within a safe zone, in which a possible voltage droop can be mitigated by switching supply to the corresponding FB frequency

However, at the bottom of the curve, there is a limit below which a possible fallback to accommodate a voltage droop lies below an acceptable voltage and frequency level that is sufficient to maintain proper operation of the circuit. This is shown as 0N, where the possible lowest point of a voltage droop (that is, the difference between NOMINAL and FALLBACK) would supply a voltage and invoke a fallback that would fall outside a safe operating zone below the operating possibilities of the circuit for the current nominal voltage/frequency state (where a safe operating zone is unavailable for the current nominal voltage/frequency state). In this case, the present technology is arranged to determine that any further lowering from 0N in case of a droop would take the circuit out of its safe operating zone by invoking a fallback to a voltage/frequency state that is below the acceptable operating level of the circuit, and thus provides a pause function to pause activity at least until the droop condition has ended.

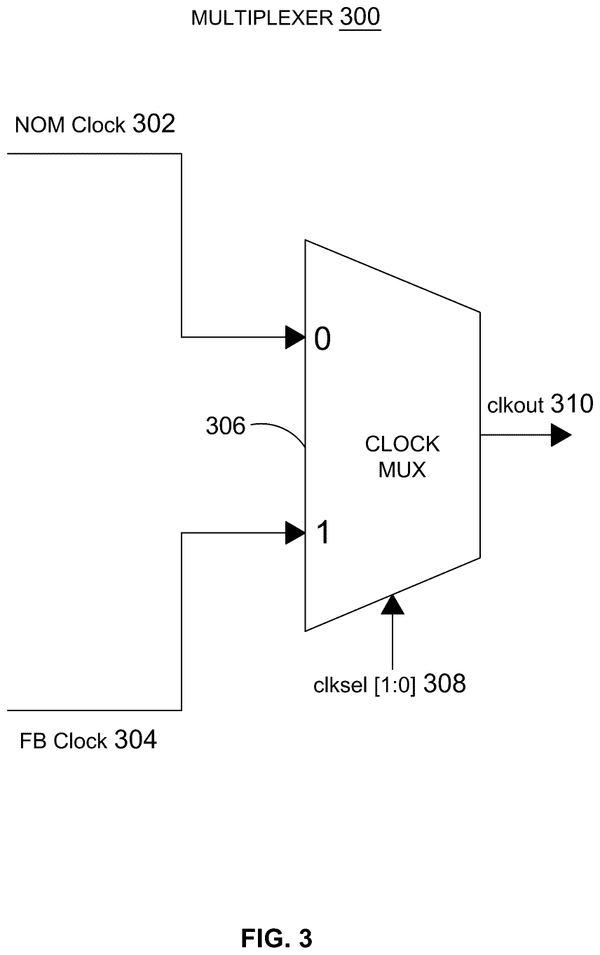

FIG. 3 shows one possible multiplexer structure operable to implement at least a part of the process of the present technology in hardware. FIG. 3 shows a multiplexer 300 arrangement operable in an electronic circuit. CLOCK MUX 306 is operable to receive inputs NOM clock 302, representing the nominal source at the current normal voltage and frequency tuning, and FB clock 304, representing the currently available fallback source at the droop mitigation voltage and frequency. CLOCK MUX 306 is controlled by clksel 308 to select the source to be used to provide output clkout 310.

FIG. 3 thus shows an implementation of a glitch-free multiplexer that can have three possible outcomes for clkout 310:
Select the NOM clock if clksel[1:0]=0′b01
Select the FB clock if clksel[1:0]=0′b10.
Select no clock if clksel[1:0]=0′b00. In other words, stop the clock propagation.

There is thus provided a method of operation, an electronic circuit, and a non-transitory computer readable medium comprising data and imperatives, each according to an aspect of the present technology. The method provides a method of controlling a dynamic voltage and frequency scaling circuit, comprising detecting a voltage droop relative to a current nominal voltage and frequency state; responsive to said current nominal voltage and frequency state having a corresponding fallback state in a safe operating zone of voltage and frequency, switching activity from a nominal source to a fallback source; and when a fallback to a safe operating zone is unavailable for said current nominal voltage and frequency state, pausing activity of the dynamic voltage and frequency scaling circuit.

The dynamic voltage and frequency scaling circuit may comprise a clock circuit. The nominal source may comprise a first phase locked loop. The fallback source may comprise a second phase locked loop. The safe operating zone may comprise a zone of the voltage domain in which there is sufficient available frequency reduction to permit continued operation in case of a maximum possible voltage droop. In one implementation, the zone outside the safe operating zone may comprise at least one zone of the voltage domain in which a maximum possible voltage droop risks rendering the circuit inoperable. The present technology may be implemented in an electronic circuit comprising electronic logic components operable to perform the steps of the method described. In a variant, the present technology may be implemented in the form of a non-transitory computer readable medium comprising a structure of data and imperatives operable to cause a device to construct a set of electronic logic components which, when embedded in an electronic device and activated thereon, cause the electronic device to perform the steps of the method defined above.

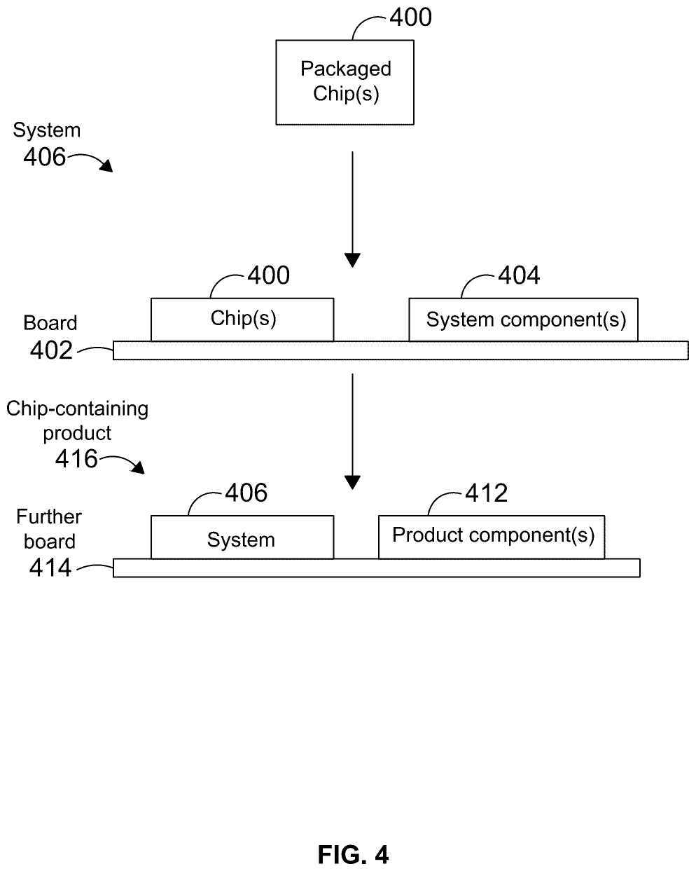

As shown in FIG. 4, one or more packaged chips 400, with the electronic circuit (or circuitry) described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the circuitry described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

As will be appreciated by one skilled in the art, the present technology may be embodied as a method, a circuit or a computer readable medium comprising data and imperatives to cause construction of a circuit. Accordingly, the present techniques may take the form of an entirely hardware embodiment, an entirely software embodiment, or an embodiment combining software and hardware. Where the word “component” is used, it will be understood by one of ordinary skill in the art to refer to any portion of any of the above embodiments.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the present techniques. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the present techniques. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the present techniques have been described in detail herein with reference to the accompanying drawings, it is to be understood that the present techniques is not limited to those precise embodiments, and that various changes and modifications can be effected therein by one skilled in the art without departing from the scope of the present techniques as defined by the appended claims.

1. A method of controlling a dynamic voltage and frequency scaling circuit, comprising:
detecting a voltage droop relative to a current nominal voltage and frequency state;
responsive to said current nominal voltage and frequency state having a corresponding fallback state in a safe operating zone of voltage and frequency, switching activity from a nominal source to a fallback source; and
when a fallback to a safe operating zone is unavailable for said current nominal voltage and frequency state, pausing activity of the dynamic voltage and frequency scaling circuit.

2. The method according to claim 1, wherein the dynamic voltage and frequency scaling circuit comprises a clock circuit.

3. The method according to claim 2, wherein the nominal source comprises a first phase locked loop.

4. The method according to claim 2, wherein the fallback source comprises a second phase locked loop.

5. The method according to claim 1, wherein the safe operating zone comprises a zone of the voltage domain in which there is sufficient available frequency reduction to permit continued operation in case of a maximum possible voltage droop.

6. The method according to claim 1, wherein outside the safe operating zone comprises at least one zone of the voltage domain in which a maximum possible voltage droop risks rendering the circuit inoperable.

7. A method of controlling a dynamic voltage and frequency scaling circuit, comprising:
detecting a voltage droop relative to a current nominal voltage and frequency state;
when a fallback to a safe operating zone is unavailable for said current nominal voltage and frequency state, pausing activity of the dynamic voltage and frequency scaling circuit.

8. An electronic circuit comprising electronic logic components operable to perform the steps of the method according to claim 1.

9. A non-transitory computer readable medium comprising a structure of data and imperatives operable to cause a device to construct a set of electronic logic components which, when embedded in an electronic device and activated thereon, cause the electronic device to perform the steps of the method according to claim 1.

10. A system comprising:
the electronic circuit of claim 8, implemented in at least one packaged chip;
at least one system component; and
a board,
wherein the at least one packaged chip and the at least one system component are assembled on the board.

11. A chip-containing product comprising the system of claim 10 assembled on a further board with at least one other product component.

12. A non-transitory computer-readable medium to store computer-readable code for fabrication of the electronic circuit of claim 8.
